(19) United States
(12) Patent Application Publication
(10) Pub. No.: US 2010/0245668 A1
(43) Pub. Date: Sep. 30, 2010

(54) PC DOCK FOR TV

(75) Inventors: Robert Hardacker, Escondido, CA (US); Christopher Jensen Read, San Diego, CA (US); Robert Allan Unger, El Cajon, CA (US)

Correspondence Address: ROGITZ & ASSOCIATES, 750 B STREET, SUITE 3120, SAN DIEGO, CA, 92101, US

(73) Assignee: SONY CORPORATION and SONY ELECTRONICS INC.

(21) Appl. No.: 12/409,882

(22) Filed: Mar. 24, 2009

(51) Int. Cl. H04N 7/00

(52) U.S. Cl. 348/552; 348/E07.091

(57) ABSTRACT

A computer dock communicates with a TV over a HDMI link and a USB and/or Ethernet link. The dock can include a keyboard and mouse and the user can select whether the keyboard/mouse signals are sent to the computer or the TV. The input devices of the computer in the dock and/or the input devices of the dock can be used to provide navigation input to the TV to navigate around user interfaces such as a cross-media bar (XMB).

### FIELD OF THE INVENTION

The present invention relates generally to PC docking stations for TVs.

### BACKGROUND OF THE INVENTION

The venerable “rabbit ears” TV antennas have become a rarity on the modern TV, which instead typically receives cable TV signals and/or satellite TV signals and/or recorded content from sources such as, e.g., digital video recorders (DVR) and digital video disk (DVD) players through a receiver broadly referred to as a “set top box” (STB). A type of STB is the so-called “set back box” (SBB) which differs from a STB chiefly by being controlled by the same remote control that controls the TV.

With the advent of high resolution digital TVs such as high definition TVs (HDTVs), to extend communication protocols to digital multimedia that includes audio for the purpose of, e.g., playing digital movies and the like, a protocol referred to as High Definition Multimedia Interface (HDMI) has been developed. HDMI is similar to Digital Visual Interface (DVI), a protocol developed primarily for computers that consequently does not envision processing audio data, except that HDMI envisions the use of audio as well as video data and it adds television-related resolutions. Both DVI and HDMI are intended for wired transmission, and HDMI further permits the encryption of digital multimedia using an encryption method known as High-Bandwidth Digital Content Protection (HDCP), which may also be used with DVI. An advantageous feature of HDMI is that it supports consumer electronics control (CEC), which permits control of the source (SB/DVD player/DVR etc.) and the TV using a single remote control.

### SUMMARY OF THE INVENTION

A dock for a PC to interface with a TV is provided so that the TV has access via the dock to resources within the PC and the likewise the PC has access to resources within the TV. For example, the TV can access in the PC hard disk storage, optical disk storage, an Internet interface, network services, flash drive ports, video camera, microphone, data entry devices. The PC can access within the TV a digital TV tuner (ATSC, QAM, etc.), an Internet interface, network services. Furthermore, processing power can be shared between the PC and TV, i.e., command processing can be apportioned between the PC and TV, e.g., the greater processing power of the PC processor may be used by the TV processor, whereas the dedicated hardware accelerated resources of the TV may be used by the PC processor.

The dock may be generic in that it can accept any portable computer using standard interfaces such as HDMI, USB, etc. Or, the dock can be a “smart dock: in that the dock operably couples the computer to the TV only if the computer and TV have prior knowledge of each other's connectability features, e.g., so that graphics commands generated in the computer are executed by a graphics processor in the TV for display of the graphics on the TV.

Accordingly, a system includes TV including a TV display and a TV processor, and a computer dock communicating with the TV processor and configured to engage a portable computer. The computer dock includes at least one user-manipulable input device generating input signals to the TV processor to navigate a user interface (UI) presented on the TV display.

The dock may be integrated in the chassis of the TV or may be separate therefrom. In example embodiments the dock communicates with the TV using a control link such as a universal serial bus (USB) link and/or an Ethernet link, and may also communicate with the TV using a high definition multimedia interface (HDMI) link.

In example implementations, a first user-generated selection signal can cause input signals from the input device of the dock to be sent to a computer disposed in a bay of the dock, while a second selection signal may cause input signals from the input device of the dock to be sent to the TV. The dock can relay signals from the TV generated by a TV remote control (RC) to a computer engaged with the dock. “Relay” can refer to no processing in the dock, but transferring signals only; or processing is split between the TV and PC; or the TV processes all commands with the PC simply providing content streams.

In another aspect, a computer dock for a TV defines a surface configured to engage a computer. The dock has at least one input device, a HDMI port configured to communicate with a TV, and a USB and/or Ethernet port configured to communicate with the TV.

In another aspect, a portable computer has a portable housing, a processor in the housing, and a computer monitor on the housing communicating with the processor. The computer also includes at least one computer input device on the housing. When the processor determines that the computer is engaged with a dock, the processor causes a user interface to be presented (on, e.g., the monitor or on a TV display associated with a TV communicating with the dock) and navigated by a user to determine whether input signals from the dock are provided as input to the TV or as input to the computer. The user interface can present, e.g., resources in the PC that are available to the TV as discussed above.

The details of the present invention, both as to its structure and operation, can best be understood in reference to the accompanying drawings, in which like reference numerals refer to like parts, and in which:

### BRIEF DESCRIPTION OF THE DRAWINGS

FIG. 1 is a block diagram of an example system in accordance with present principles, schematically showing internal components of the TV;

FIG. 2 is a block diagram of another example system schematically showing some components;

FIG. 3 is a screen shot of the cross-media bar (XMB) graphical user interface (GUI) for use in connection with the PC; and

FIGS. 4 and 5 illustrate example logic.

### DETAILED DESCRIPTION OF THE PREFERRED EMBODIMENT

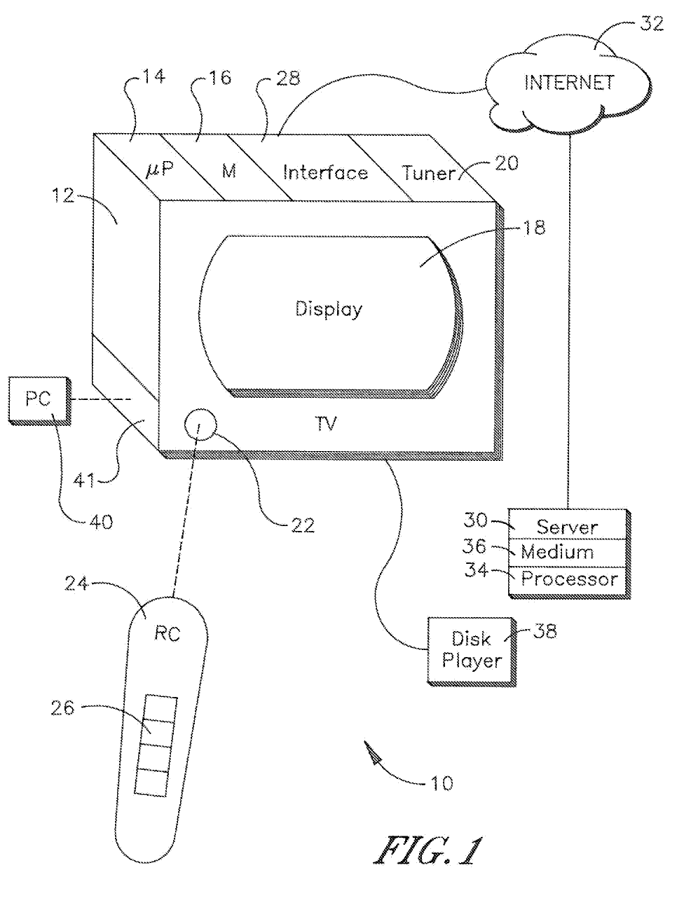

Referring initially to FIG. 1, a system is shown, generally designated 10, which includes a TV 12 having a TV processor 14 accessing a computer readable storage medium 16 such as but not limited to solid state storage and/or disk based storage to present TV signals on a TV display 18, such as a flat panel LCD display or other type of matrix display or a plasma display or other suitable type of TV display. The signals are received through a TV tuner 20 that communicate with a suitable source of TV signals. The TV 12 typically includes a wireless receiver 22 such as an infrared receiver for receiving user command signals from a remote control 24. The remote control 24 typically includes one or more manipulable input elements 26 such as keys for enabling a user to input commands to the TV processor 14.

As shown in FIG. 1, the TV 12 may also include a network interface 28 such as but not limited to a wired or wireless modem for enabling the TV processor 14 to communicate with one or more servers 30 over a wide area network such as the Internet 32. The network interface 28 may be incorporated within the chassis of the TV 12 or it may be included in a set-top box or set-back box operably engaged with the TV 12. In any case, the server 30 includes one or more server processors 34 accessing a server data storage medium 36.

An optical disk player 38 may also communicate with the TV processor 14 using HDMI as well as a universal serial bus (USB) link for control. Furthermore, a personal computer 40 can communicate with the TV processor. In the embodiment shown in FIG. 1, the PC 40 engages a dock 41 that is incorporated in the chassis of the TV as shown, e.g., the end of the dock 41 facing the PC 40 is flush with the side of the TV chassis as shown.

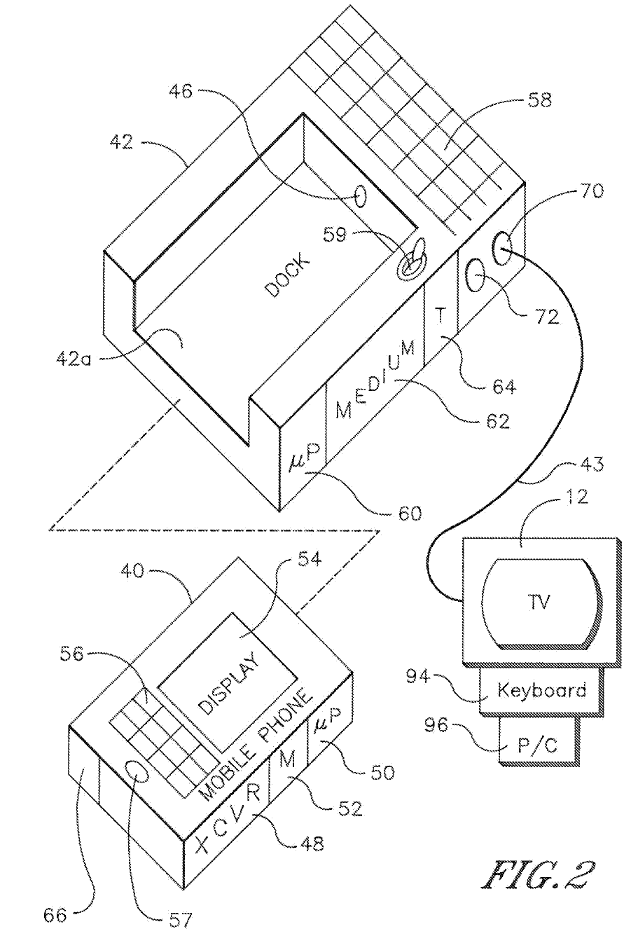

In the embodiment shown in FIG. 2, on the other hand, the PC 40 engages a dock 42 that is separate from the TV and that is connected thereto as will be shortly disclosed. Other than the differences in whether they are integral to or separate from the TV, the docks 41, 42 may be substantially identical in configuration and function.

Accordingly, for a fuller understanding of the PC dock and referring to the details of FIG. 2, the PC dock 42 may communicate with a TV through one or more wired or wireless links 43. The links 43 may include a HDMI link and a control link such as a universal serial bus (USB) link and/or Ethernet link. The dock 42 includes a bay 42a that in example embodiments may be configured complementarily to the computer 40, i.e., the bay 42a may have the same contour as the computer 40 and may have substantially the same volume as the computer 40, such that the computer 40 fits snugly in the bay 42a. A contact 46 may be provided in the bay 42a as shown such that when the computer 40 is disposed as intended in the bay 42a, the contact 46 generates a “dock mode” signal that may causes the TV to switch to using signals from the dock (and, hence, from the computer 40) as input for the TV display 16. Other uses of the dock signal are envisioned, e.g., the dock signal can be provided to the PC to launch a user interface application, in which the PC sends icon information and other control information through the dock to the TV over, e.g., the above-described USB and/or Ethernet link, for purposes to be shortly disclosed.

The PC 40 may be, without limitation, a laptop computer or notebook computer which may include a wired or wireless network transceiver 48 controlled by a PC processor 50 accessing instructions on a computer readable medium 52. The transceiver 48 is configured to communicate with the Internet. The PC 40 also typically has a relatively small display 54 that is smaller than the TV display 16. Also, the computer 40 typically has a keyboard or keypad 56 and point and click device 57.

The dock 42 may include a wired or wireless keypad 58 that in some example embodiments may be provided on the dock 42 itself or near the dock 42 and connected thereto by a wired or wireless link. In some embodiments the dock 42 may further include a wired or wireless pointing and clicking device 59 such as a mouse or joystick. In some implementations the dock keyboard or keypad 58 is a conventional QWERTY arrangement although other arrangements can be made. In any case, the dock 42 may include a dock processor 60 accessing instructions on a computer readable medium 62. The dock 42 may also include a wired or wireless network transceiver 64 configured to communicate with the Internet.

In other implementations the PC 40 may not mechanically engage the dock 42, but instead maybe placed near the dock 42 and may communicate therewith through a wired or wireless link such as a USB link, a Bluetooth link, a 60 GHz wireless link, or other link.

When the PC 40 is engaged with the dock 41 or 42 as intended in the examples shown, output from the PC processor 50 is presented through the dock 42 on the TV display 16, while input to the PC processor 50 may be made through the dock keyboard or keypad 58 and/or pointing and clicking device 59. Or, input to the PC may be effected using the RC 24 as more fully described below. In either case, the dock processor 60, when provided, can cooperate with the PC processor 50 and as mentioned above may communicate therewith through a wired or wireless link or through direct contact between exposed connectors on the phone and dock.

As mentioned above, the dock 41/42 can communicate with the TV using a HDMI link over which multimedia data from, e.g., an optical disk player 66 in the PC 40 may be conveyed for display on the TV, as well as a USB link, over which control signals between the TV processor and the PC processor may be conveyed. Accordingly, since, as understood herein, the USB protocol is not bipolar, a USB port 70 of the dock 42 may be a device USB link, with the dock 42 also potentially including a host USB port 72 if desired, with USB device ports not being the same as USB host ports. The TV's USB port receiving the USB link may be a USB host port, however. Likewise, the PC 40 can communicate with the dock 42 over a HDMI link as well as a USB and/or network (e.g., Ethernet) link (established by wired or wireless connections, contacts within the dock 42 that mate with corresponding contacts on the PC, or otherwise). The PC 40 may also have a device USB port as well as a host USB port.

Once the PC 40 is connected via HDMI and USB/Ethernet to the TV processor 14 through the dock 42 as indicated by, e.g., the above-mentioned dock signal, the TV processor 14 may configure the display 18 to present a cross media bar (XMB) user interface listing available sources of multimedia input for display. As shown in FIG. 3, a XMB 74 may include a TV/cable input selection and a disk player 38 input selection. Furthermore, the XMB 74 may include an entry 76 for the dock 42/PC 40 and/or the optical disk player 46 of the PC and/or the network connection of the PC, from which streaming multimedia may be obtained. List information as to the available titles on the PC disk player, information pertaining to the icon representing the PC that is to be displayed on the XMB, etc. may be transferred from the PC to the TV over the control (USB and/or Ethernet) link and presented on the XMB 74.

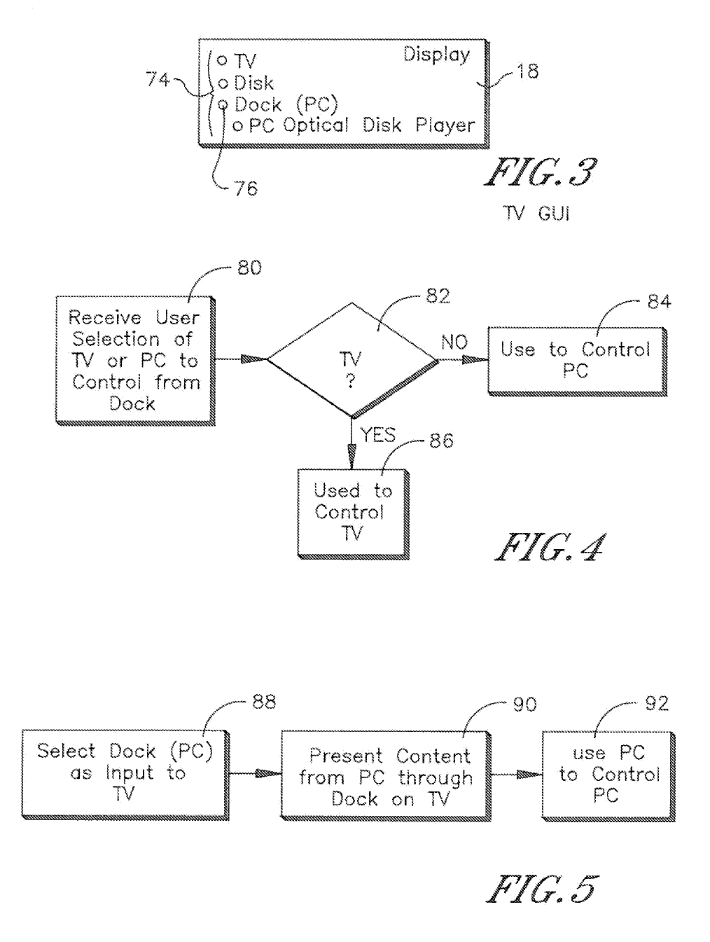

Now referring to FIG. 4, owing to the existence of the above-described control link, the dock keyboard 58 and dock point and click device 59, conventionally used for input to the PC, may also be used to control of the TV. Thus, at block 80 in FIG. 4, when the above-described application is launched in the PC upon engagement of the PC with the dock, the user is permitted to select (via, e.g., a user interface presented on any of the displays above in cooperation with one or more of the input devices described herein) which component—the PC, or the TV—is to receive the input signals generated by the dock input devices.

If the PC is selected at decision diamond 82, the signals generated by the dock input devices are used to control the PC at block 84. On the other hand, if the TV is selected at decision diamond 82, the signals generated by the dock input devices are used to control the TV at block 86. In this way, in addition to or in lieu of using the RC 24 to input commands to the TV, a user may manipulate the dock input devices to, e.g., navigate around various TV UIs such as the XMB shown in FIG. 3, type in station identifications to cause the TV to tune to the respective stations or channels, set up a TV favorites list, and in general some or all of the functions that the RC 24 otherwise may be used for.

Additionally, as shown in FIG. 5, at block 88 a user can, using the remote control 24 and/or the dock input devices when “TV” is selected in FIG. 4, select from the XMB 74 the PC disk player 66 (or the PC network transceiver 48 or dock network transceiver 64) as the input source to the display 18. This causes, at block 90, content from a disk in the PC disk player 66 (or streaming Internet content from the PC transceiver 48 or dock transceiver 64) to be sent over the HDMI link to the TV for presentation on the TV display 18. Furthermore, at block 92 the user can manipulate the RC 24 as appropriate to input commands into the TV and thence over the control link (or, if desired, over the CEC component of the HDMI link) to the dock, which relays the commands to the PC processor 42 to control the PC disk player 66 (or web browser executed by the PC processor or dock processor to control the respective networks transceivers). The commands can include, e.g., disk player commands such as stop, play, fast forward, skip, etc. In this way, the PC 40 is tightly coupled to the TV 12 through the dock 41/42 as an adjunct multimedia processing and input source to the TV.

In variations, the dock input devices can be manipulated to effect the above selections and commands in lieu of the RC 24. Thus, for example, a user may use the arrow keys of the dock keyboard 58 or a user may use the dock mouse 59 to select an input source from the XMB. In some variations, the PC processor 42 may execute conventional PC tasks such as, for example, word processing, in which case the PC processor 42 uses the TV display 18 as an output device to, e.g., present over the HDMI link or USB link the text of a document being executed by the PC processor 42 using a word processing application.

In some embodiments, when content from the PC is presented on the TV, the PC may decode the content, send the content over the HDMI link and send associated user interface information over the control link to the TV. If no HDMI link is provided from the PC to the TV through the dock, and only, e.g., a USB link is provided, the PC may encrypt the content and then send it to the TV for decryption, decoding, and rendering.

In some embodiments, referring back to FIG. 2 the TV itself may include a keyboard 94 and a point and click device 96, and when a docked PC is selected as the input source to the TV, the TV's input devices may be used to control the PC in lieu of using the dock input devices.

It may now be appreciated that owing to the above-described communication links and coupling of the PC to the TV through the dock, when the TV has no network interface 28 the network connectivity of the dock and/or PC can be extended to the TV. Likewise, when the TV has a network interface 28 the network connectivity of the TV can be extended to the PC (if the PC has no network connection) through the dock across the control link.

While the particular PC DOCK FOR TV is herein shown and described in detail, it is to be understood that the subject matter which is encompassed by the present invention is limited only by the claims.

What is claimed is:

1. System comprising:
TV including a TV display and a TV processor;
computer dock communicating with the TV processor and configured to engage a portable computer, the computer dock including at least one user-manipulable input device generating input signals to the TV processor to navigate a user interface (UI) presented on the TV display.

2. The system of claim 1, wherein the TV defines a TV chassis and the dock is in the chassis.

3. The system of claim 1, wherein the TV defines a TV chassis and the dock is outside the chassis.

4. The system of claim 1, wherein the dock communicates with the TV using a control link.

5. The system of claim 4, wherein the control link is a universal serial bus (USB) link and/or an Ethernet link.

6. The system of claim 5, wherein the dock communicates with the TV using a high definition multimedia interface (HDMI) link.

7. The system of claim 1, wherein a first selection signal causes input signals from the input device to be sent to a computer disposed in a bay of the dock and a second selection signal causes input signals from the input device to be sent to the TV.

8. The system of claim 1, wherein the dock relays signals from the TV generated by a TV remote control (RC) to a computer engaged with the dock.

9. A computer dock for a TV comprising:
surface configured to engage a computer;
at least one input device;
HDMI port configured to communicate with a TV;
USB and/or Ethernet port configured to communicate with the TV.

10. The dock of claim 9, wherein the input device generates input signals to a TV processor in the TV to navigate a user interface (UI) presented on a TV display.

11. The dock of claim 9, wherein the TV defines a TV chassis and the dock is in the chassis.

12. The dock of claim 9, wherein the TV defines a TV chassis and the dock is outside the chassis.

13. The dock of claim 9, wherein a first selection signal causes input signals from the input device to be sent to a computer disposed on the surface of the dock and a second selection signal causes input signals from the input device to be sent to the TV.

14. The dock of claim 9, wherein the dock relays signals from the TV generated by a TV remote control (RC) to a computer engaged with the dock.

15. Portable computer comprising:
portable housing;
processor in the housing;
computer monitor on the housing communicating with the processor;
at least one computer input device on the housing, wherein when the processor determines that the computer is engaged with a dock, the processor causes a user interface to be presented and navigated by a user to determine whether input signals from the dock are provided as input to a TV communicating with the dock or as input to the computer.

16. Computer of claim 15, wherein the input signals cause a screen cursor to navigate a user interface (UI) presented on a display of the TV.

17. Computer of claim 15, wherein the dock communicates with the TV using a control link.

18. Computer of claim 17, wherein the control link is a universal serial bus (USB) link and/or an Ethernet link.

19. Computer of claim 18, wherein the dock communicates with the TV using a high definition multimedia interface (HDMI) link.

20. Computer of claim 15, wherein the dock relays signals from the TV generated by a TV remote control (RC) to the computer, the computer processor receiving the signals from the TV and controlling a disk player in the computer in accordance therewith.
